(19) United States
(12) Patent Application Publication
(10) Pub. No.: US 2026/0037178 A1
(43) Pub. Date: Feb. 5, 2026

(54) DATA STORAGE METHOD AND STORAGE DEVICE

(71) Applicant: Hosin Global Electronics Co., LTD, Shenzhen (CN)

(72) Inventors: Xiao Min Chen, Shenzhen (CN); Tsung-Lin Wu, Hsinchu City (TW); Chao-Yu Chen, Shenzhen (CN); Hai Liang Wu, Shenzhen (CN); Kai Qiang Meng, Shenzhen (CN); Jing Wan, Shenzhen (CN); Hao Wang, Shenzhen (CN); Yuan Hong Ye, Shenzhen (CN); Qi Ming Zhu, Shenzhen (CN); Wei Wang, Shenzhen (CN)

(73) Assignee: Hosin Global Electronics Co., LTD, Shenzhen (CN)

(21) Appl. No.: 19/082,135

(22) Filed: Mar. 17, 2025

(30) Foreign Application Priority Data
Aug. 5, 2024 (CN) 202411065632.6

(51) Int. Cl. G06F 3/06

(52) U.S. Cl. CPC G06F 3/0656; G06F 3/0619; G06F 3/0653; G06F 3/0679

(57) ABSTRACT

The invention provides a data storage method and a storage device. The method includes: obtaining first data and second data; caching the first data in a first buffer in a plurality of buffers, wherein the first buffer is connected to a first physical group; caching the second data in a second buffer in the plurality of buffers, wherein the second buffer is connected to a second physical group; and storing the first data cached in the first buffer and the second data cached in the second buffer into the first physical group sequentially. Therefore, balance may be achieved between reducing costs, maintaining basic data write operations, and reducing write amplification.

### CROSS-REFERENCE TO RELATED APPLICATION

This application claims the priority benefit of China application serial no. 202411065632.6 filed on Aug. 5, 2024. The entirety of the above-mentioned patent application is hereby incorporated by reference herein and made a part of this specification.

### BACKGROUND OF THE INVENTION

### Field of the Invention

The invention relates to the field of storage techniques, and in particular to a data storage method and a storage device.

### Description of Related Art

In the field of storage techniques, some types of storage devices have internal configurations of buffers corresponding to different physical groups (e.g., planes). Before data is stored in a specific physical group, the data is first cached in a corresponding buffer, and then the data cached in the buffer is stored in the corresponding physical group. However, as the data storage density of memory cells within the storage device is gradually increased, the capacity of the buffer is gradually insufficient. For example, for a memory module operating in a triple-level cell (TLC) mode, when storing data, the data needs to be written to three physical pages in the memory module continuously to ensure the stability of the stored data. However, the capacity of the buffer corresponding to each physical group may be only sufficient to store the data of one physical page.

In general, in order to solve the above issue of insufficient capacity of the buffer, some physical blocks in some types of memory modules are planned as cache blocks and operated in single-level cell (SLC) mode to match or replace the buffer to cache the data to be stored. However, in the long run, this mechanism causes additional write amplification (WAF) to the memory module, thereby shortening the service life of the memory module or the storage device. In addition, if the capacity of the buffer is increased, the device construction cost is increased.

Therefore, how to strike a balance between reducing costs, maintaining basic data write operations, and reducing write amplification is an issue that needs to be solved urgently.

### SUMMARY OF THE INVENTION

The invention provides a data storage method and a storage device that may solve the issue of insufficient capacity of the buffer and achieve balance between reducing costs, maintaining basic data write operations, and reducing write amplification.

An embodiment of the invention provides a data storage method used in a storage device, wherein the storage device includes a memory module, the memory module includes a plurality of buffers and a plurality of physical groups, the plurality of buffers are respectively connected to the plurality of physical groups, and the data storage method includes: obtaining first data and second data; caching the first data in a first buffer in the plurality of buffers, wherein the first buffer is connected to a first physical group in the plurality of physical groups; caching the second data in a second buffer in the plurality of buffers, wherein the second buffer is connected to a second physical group in the plurality of physical groups; and storing the first data cached in the first buffer and the second data cached in the second buffer sequentially in the first physical group.

An embodiment of the invention further provides a storage device including a connection interface, a memory module, and a memory controller. The connection interface is configured to be connected to a host system. The memory controller is connected to the connection interface and the memory module. The memory module includes a plurality of buffers and a plurality of physical groups, the plurality of buffers are respectively connected to the plurality of physical groups, and the memory controller is configured to: obtain first data and second data; cache the first data in a first buffer in the plurality of buffers, wherein the first buffer is connected to a first physical group in the plurality of physical groups; cache the second data in a second buffer in the plurality of buffers, wherein the second buffer is connected to a second physical group in the plurality of physical groups; and store the first data cached in the first buffer and the second data cached in the second buffer sequentially in the first physical group.

Based on the above, the first data and the second data may be cached in the first buffer and the second buffer in the plurality of buffers respectively. In particular, the first buffer and the second buffer may be respectively connected to the first physical group and the second physical group in the plurality of physical groups. Then, the first data cached in the first buffer and the second data cached in the second buffer may be stored in the first physical group in sequence. Therefore, it is possible to ensure that the data write operation on the memory module may still be smoothly executed without additionally increasing the capacity of the buffer and the write amplification. At the same time, balance may be achieved between reducing costs, maintaining basic data write operations, and reducing write amplification.

### BRIEF DESCRIPTION OF THE DRAWINGS

FIG. 1 is a schematic diagram of a data storage system shown according to an embodiment of the invention.

FIG. 2 is a schematic diagram of a memory controller shown according to an embodiment of the invention.

FIG. 3 is a schematic diagram of managing a memory module shown according to an embodiment of the invention.

FIG. 4 is a schematic diagram of a memory module shown according to an embodiment of the invention.

FIG. 5 is a schematic diagram of a memory module shown according to an embodiment of the invention.

FIG. 6 to FIG. 9 are schematic diagrams of data storage operations shown according to an embodiment of the invention.

FIG. 10 and FIG. 11 are schematic diagrams of data storage operations shown according to an embodiment of the invention.

FIG. 12 is a flowchart of a data storage method shown according to an embodiment of the invention.

FIG. 13 is a flowchart of a data storage method shown according to an embodiment of the invention.

### DESCRIPTION OF THE EMBODIMENTS

Reference will now be made in detail to the exemplary embodiments of the disclosure, examples of which are illustrated in the accompanying drawings. Wherever possible, the same reference numerals are used in the drawings and descriptions to refer to the same or like portions.

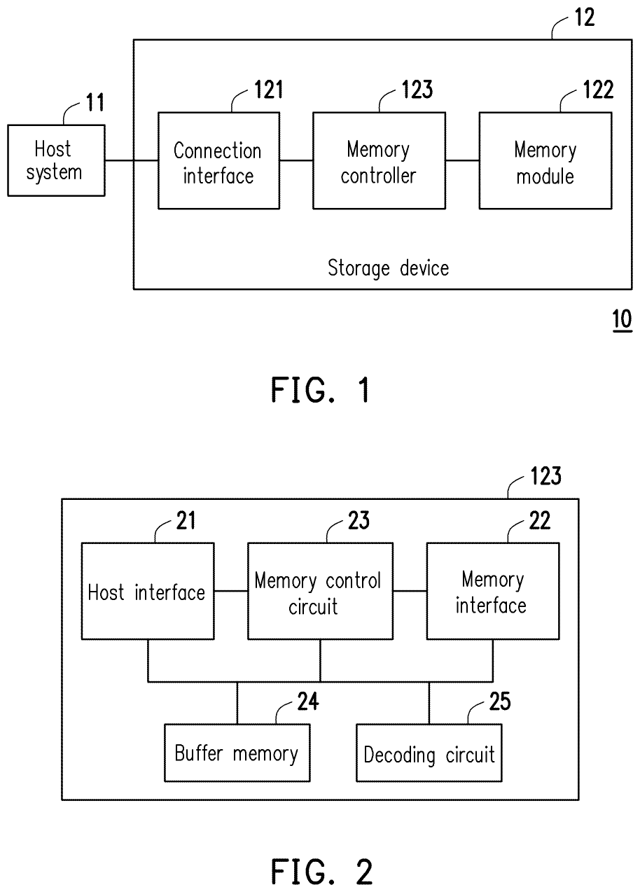

FIG. 1 is a schematic diagram of a data storage system shown according to an embodiment of the invention. Referring to FIG. 1, a data storage system 10 includes a host system 11 and a storage device 12. The storage device 12 may be connected to the host system 11 and may be configured to store data from the host system 11. For example, the host system 11 may be a smart phone, a tablet computer, a notebook computer, a desktop computer, an industrial computer, a game console, a server, or a computer system disposed at a specific carrier (such as a vehicle, an aircraft, or a ship), and the type of the host system 11 is not limited thereto. Moreover, the storage device 12 may include a solid-state drive, a USB flash drive, a memory card, or other types of non-volatile storage devices.

The storage device 12 includes a connection interface 121, a memory module 122, and a memory controller 123. The connection interface 121 is configured to connect the storage device 12 to the host system 11. For example, the connection interface 121 may support embedded Multi-Media Card (eMMC), Universal Flash Storage (UFS), Peripheral Component Interconnect Express (PCI Express), Non-Volatile Memory Express (NVM express), Serial Advanced Technology Attachment (SATA), Universal Serial Bus (USB), or other types of connection interface standards. Therefore, the storage device 12 may communicate (e.g., exchange signals, commands, and/or data) with the host system 11 via the connection interface 121.

The memory module 122 is configured to store data. For example, the memory module 122 may include one or a plurality of rewritable non-volatile memory modules. Each rewritable non-volatile memory module may include one or a plurality of memory cell arrays. The memory cells in the memory cell arrays store data in the form of voltage (also called threshold voltage). For example, the memory module 122 may include a single-level cell (SLC) NAND flash memory module, a multi-level cell (MLC) NAND flash memory module, a triple-level cell (TLC) NAND flash memory module, a quad-level cell (QLC) NAND flash memory module, and/or other memory modules having the same or similar characteristics.

The memory controller 123 is connected to the connection interface 121 and the memory module 122. The memory controller 123 may be regarded as a control core of the storage device 12 and is configured to control the storage device 12. For example, the memory controller 123 may be configured to control or manage the entire or partial operation of the storage device 12. For example, the memory controller 123 may include a central processing unit (CPU), or other programmable general-purpose or special-purpose microprocessors, digital signal processors (DSPs), programmable controllers, application-specific integrated circuits (ASICs), programmable logic devices (PLDs), or other similar devices, or a combination of these devices. In an embodiment, the memory controller 123 may include a flash memory controller.

The memory controller 123 may send a command sequence to the memory module 122 to access the memory module 122. For example, the memory controller 123 may send a write command sequence to the memory module 122 to instruct the memory module 122 to store the data in a specific memory cell. For example, the memory controller 123 may send a read command sequence to the memory module 122 to instruct the memory module 122 to read data from a specific memory cell. For example, the memory controller 123 may send an erase command sequence to the memory module 122 to instruct the memory module 122 to erase the data stored in a specific memory unit. In addition, the memory controller 123 may also send other types of command sequences to the memory module 122 to instruct the memory module 122 to perform other similar operations, which is not limited in the invention. The memory module 122 may receive a command sequence from the memory controller 123 and access memory cells within the memory module 122 according to the command sequence.

FIG. 2 is a schematic diagram of a memory controller shown according to an embodiment of the invention. Referring to FIG. 1 and FIG. 2, the memory controller 123 includes a host interface 21, a memory interface 22, and a memory control circuit 23. The host interface 21 is configured to be connected to the host system 11 via the connection interface 121 to communicate with the host system 11. The memory interface 22 is configured to be connected to the memory module 122 to access the memory module 122.

The memory control circuit 23 is connected to the host interface 21 and the memory interface 22. The memory control circuit 23 may be configured to control or manage the whole or part of the operation of the memory controller 123. For example, the memory control circuit 23 may communicate with the host system 11 via the host interface 21 and access the memory module 122 via the memory interface 22. For example, the memory control circuit 23 may include a control circuit such as an embedded controller or a microcontroller. In the following embodiments, the description of the memory control circuit 23 is equivalent to the description of the memory controller 123.

In an embodiment, the memory controller 123 may further include a buffer memory 24. The buffer memory 24 is connected to the memory control circuit 23 and configured to cache data. For example, the buffer memory 24 may be configured to cache a command from the host system 11, data from the host system 11, and/or data from the memory module 122.

In an embodiment, the memory controller 123 may further include a decoding circuit 25. The decoding circuit 25 is connected to the memory control circuit 23 and configured to encode and decode the data to ensure the correctness of the data. For example, the decoding circuit 25 may support various encoding/decoding algorithms such as Low Density Parity Check code (LDPC code), BCH code, Reed-Solomon code (RS code), Exclusive OR (XOR) code.

In an embodiment, the memory controller 123 may further include other types of circuit modules (such as a debug circuit and a power management circuit, etc.), which is not limited by the invention.

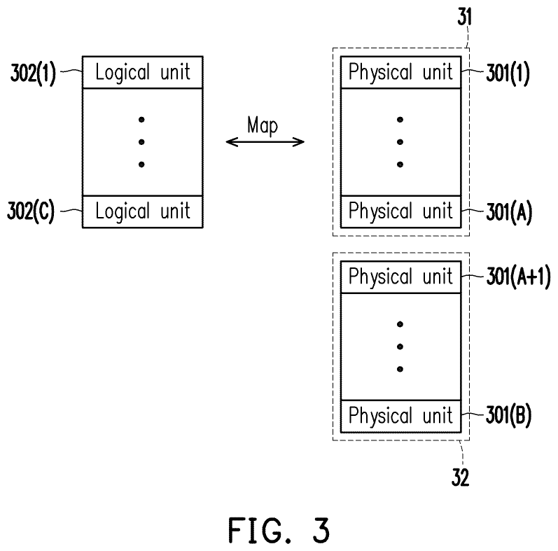

FIG. 3 is a schematic diagram of managing a memory module shown according to an embodiment of the invention. Referring to FIG. 1 to FIG. 3, the memory module 122 includes a plurality of physical units 301(1) to 301(B). Each physical unit includes a plurality of memory cells and is configured to store data in a non-volatile manner.

In an embodiment, one physical unit may include one or a plurality of physical programming units. One physical programming unit may include a plurality of physical sectors. For example, the data capacity of one physical sector may be 512 bytes (B), and one physical programming unit may include 32 physical sectors. However, the data capacity of one physical sector and/or the total number of physical sectors included in one physical programming unit may be adjusted according to practical needs, and the invention is not limited thereto. In an embodiment, one physical programming unit may be regarded as one physical page. For example, the storage capacity of one physical programming unit may be 16 kilobytes (KB), but the invention is not limited thereto.

In an embodiment, one physical programming unit is the minimum unit of synchronously writing data in the memory module 122. For example, when a programming operation (also referred to as a write operation) is performed on one physical programming unit to write data into the physical programming unit, a plurality of memory cells in the physical programming unit may be programmed synchronously to store corresponding data. For example, when programming one physical programming unit, a write voltage may be applied to the physical programming unit to change the threshold voltage of at least a portion of the memory cells in the physical programming unit. For example, the threshold voltage of each memory unit may reflect the bit data stored in the memory unit.

In an embodiment, one physical erase unit may include a plurality of physical programming units. A plurality of physical programming units in one physical erase unit may be erased simultaneously. For example, when an erase operation is performed on one physical erase unit, an erase voltage may be applied to a plurality of physical programming units in the physical erase unit to change the threshold voltages of at least some of the memory cells in the physical programming units. By performing an erase operation on one physical erase unit, data stored in the physical erase unit may be cleared.

In an embodiment, the memory control circuit 23 may logically associate the physical units 301(1) to 301(A) and 301(A+1) to 301(B) to a data area 31 and a spare area 32, respectively. The physical units 301(1) to 301(A) in the data area 31 all store data (also referred to as user data) from the host system 11. For example, any physical unit in the data area 31 may store valid data and/or invalid data. Moreover, the physical units 301(A+1) to 301(B) in the spare area 32 all do not store data (e.g., valid data).

In an embodiment, if a certain physical unit does not store valid data, the physical unit may be associated with the spare area 32. In addition, the physical unit in the spare area 32 may be erased to clear the data in the physical unit. In an embodiment, the physical units in the spare area 32 are also referred to as idle physical units. In an embodiment, the spare area 32 is also called a free pool.

In an embodiment, when data is to be stored, the memory control circuit 23 may select one or a plurality of physical units from the spare area 32 and instruct the memory module 122 to store the data in the selected physical units. After the data is stored in the physical units, the physical units may be associated with the data area 31. In other words, one or a plurality of physical units may be used alternately between the data area 31 and the spare area 32.

In an embodiment, the memory control circuit 23 may configure a plurality of logical units 302(1) to 302(C) to map the physical units (i.e., the physical units 301(1) to 301(A)) in the data area 31. For example, one logical unit may correspond to one logical block address (LBA) or other logical management units. One logical unit may be mapped to one or a plurality of physical units.

In an embodiment, if a certain physical unit is currently mapped by any logical unit, the memory control circuit 23 may determine that the data currently stored in the physical unit includes valid data. On the contrary, if a certain physical unit is not currently mapped by any logical unit, the memory control circuit 23 may determine that the physical unit does not currently store any valid data.

In an embodiment, the memory control circuit 23 may record the mapping relationship between logical units and physical units in at least one management table (also referred to as a logical-to-physical mapping table). In an embodiment, the memory control circuit 23 may instruct the memory module 122 to perform an operation such as data reading, writing, or erasing according to the information in the management table (i.e., the logical-to-physical mapping table).

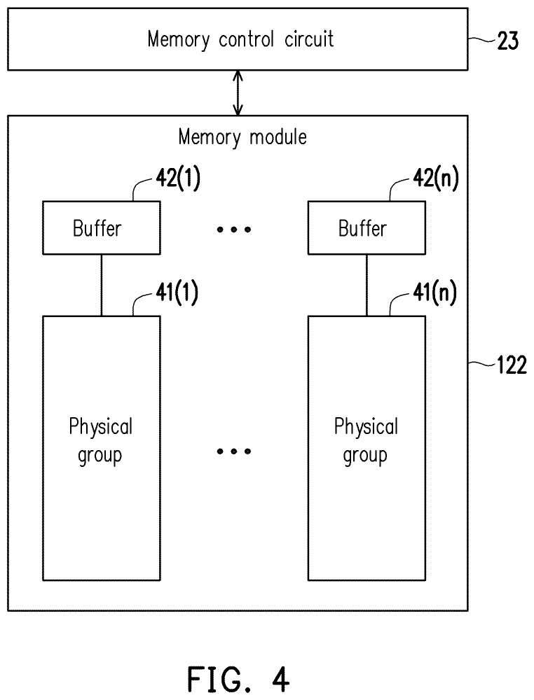

FIG. 4 is a schematic diagram of a memory module shown according to an embodiment of the invention. Referring to FIG. 4, the memory module 122 may include physical groups 41(1) to 41(n) and buffers 42(1) to 42(n). Each physical group in the physical groups 41(1) to 41(n) may include a plurality of physical units. For example, the physical group 41(i) includes a plurality of physical units in FIG. 3, and i may be any integer between 1 and n. It should be noted that one physical unit may only be included in one of the physical groups 41(1) to 41(n).

In an embodiment, one physical group (e.g., the physical group 41(i)) in the physical groups 41(1) to 41(n) corresponds to one plane (also referred to as a memory plane) in the memory module 122. For example, all physical units belonging to the physical group 41(i) are located in a certain plane (also called the first plane) in the memory module 122, and all physical units belonging to the physical group 41(j) are located in another plane (also called the second plane) in the memory module 122, wherein j may be any integer between 1 and n, and i is not equal to j. In an embodiment, one physical group (e.g., the physical group 41(i)) in the physical groups 41(1) to 41(n) may also correspond to other physical management units, which is not limited in the invention.

The buffers 42(1) to 42(n) are connected to the physical groups 41(1) to 41(n) respectively. For example, the buffer 42(i) may be connected to the physical group 41(i). In general, the buffer 42(i) may be configured to cache data expected to be stored (or written) in the physical group 41(i). That is, before specific data is stored in any physical unit in the physical group 41(i), the specific data is first cached in the buffer 42(i) and then written from the buffer 42(i) to the predetermined physical unit in the physical group 41(i). However, in certain cases, the buffer 42(i) may also be configured to cache data expected to be stored (or written) in the physical group 41(j).

In an embodiment, the memory control circuit 23 may obtain the first data and the second data. For example, the first data and/or the second data may include data stored as instructed by at least one operation command (e.g., a write command) obtained from the host system 11. Alternatively, the first data and/or the second data may also include data read from the memory module 122 and waiting to be stored back in the memory module 122.

It is understandable that the second data may be just one piece of data, or may be a plurality of divided pieces of data, and the present application does not make any specific limitation here.

In an embodiment, at least one of the first data and the second data may also include padding data. For example, the padding data may include invalid data and/or meaningless data (e.g., a plurality of “1”s or “0”s). Furthermore, the padding data may not include data obtained from the host system 11 and/or data read from the memory module 122.

In an embodiment, the memory control circuit 23 may cache the first data in a certain buffer (also referred to as a first buffer) in the buffers 42(1) to 42(n). The first buffer is connected to a certain physical group (also referred to as a first physical group) in the physical groups 41(1) to 41(n). Moreover, the memory control circuit 23 may cache the second data in another buffer (also referred to as a second buffer) in the buffers 42(1) to 42(n). The second buffer is connected to another physical group (also referred to as a second physical group) in the physical groups 41(1) to 41(n). Then, the memory control circuit 23 may instruct the memory module 122 to sequentially store (e.g., write) the first data cached in the first buffer and the second data cached in the second buffer to the first physical group.

In an embodiment, it is assumed that the first data is expected to be stored in a certain physical unit (also referred to as a first physical unit) in the first physical group, and the second data is expected to be stored in another physical unit (also referred to as a second physical unit) in the first physical group. After the first data is cached in the first buffer, the memory control circuit 23 may instruct the memory module 122 to store the first data cached in the first buffer in the first physical unit. After the first data is stored in the first physical unit, the memory control circuit 23 may instruct the memory module 122 to store the second data cached in the second buffer in the second physical unit. In particular, the first physical unit and the second physical unit both belong to the first physical group.

In an embodiment, it is assumed that the first physical group, the first buffer, the second physical group, and the second buffer are the physical group 41(i), the buffer 42(i), the physical group 41(j), and the buffer 42(j) respectively. After the first data and the second data are stored in the buffer 42(i) and the buffer 42(j) respectively, the memory control circuit 23 may instruct the memory module 122 to first store the first data currently cached in the buffer 42(i) in a certain physical unit (i.e., the first physical unit) in the physical group 41(i). After the first data is stored in the first physical unit, the memory control circuit 23 may move the second data currently cached in the buffer 42(j) to the buffer 42(i) to replace (e.g., overwrite) the first data originally cached in the buffer 42(i). Next, the memory control circuit 23 may instruct the memory module 122 to store the second data currently cached in the physical group 41(i) in another physical unit (i.e., the second physical unit) in the physical group 41(i).

In other words, in an embodiment, due to certain reasons (for example, the capacity of the buffer 42(i) is insufficient to store the first data and the second data at the same time), the first data and the second data may be stored in a plurality of buffers (for example, the buffers 42(i) and 42(j)) in the buffers 42(1) to 42(n) in a dispersed manner. In a subsequent write operation, the first data and the second data may be sequentially stored in the physical group 41(i) via the buffer 42(i). Therefore, without additionally increasing the capacity of the buffer 42(i) and the write amplification, the data write operation of the memory module 122 may still be performed smoothly.

In an embodiment, the memory control circuit 23 may determine the first physical unit according to an operation command corresponding to the first data (also referred to as a first operation command). For example, the first operation command is configured to instruct the memory module 122 to store the first data in the first physical unit. For example, the first operation command may carry address information of the first physical unit. After the first physical unit is determined, the memory control circuit 23 may determine the first buffer from the buffers 42(1) to 42(n) according to the physical group (i.e., the first physical group) to which the first physical unit belongs. For example, the memory control circuit 23 may determine a buffer in the buffers 42(1) to 42(n) connected to the first physical group as the first buffer.

In an embodiment, the memory control circuit 23 may further determine at least one buffer (also referred to as an idle buffer) from the buffers 42(1) to 42(n). The idle buffer refers to the buffer currently in an idle state in the buffers 42(1) to 42(n). For example, if a certain buffer does not currently cache data waiting to be stored in a certain physical group, the buffer may be determined to be in the idle state. However, if a certain buffer currently caches data waiting to be stored in a certain physical group, the buffer may be determined to be not in the idle state.

In an embodiment, after at least one idle buffer is determined, the memory control circuit 23 may determine a second buffer from the at least one idle buffer. That is, after the at least one idle buffer is determined, the memory control circuit 23 may select one of the at least one idle buffer as a buffer (i.e., the second buffer) temporarily used to cache the second data. In particular, compared to the first buffer, the second buffer is connected to the second physical group. In an embodiment, the second buffer is not connected to the first physical group.

In an embodiment, the memory control circuit 23 may analyze at least one operation command in a command queue. The at least one operation command is configured to instruct the memory module 122 to store data in at least one physical unit. For example, the at least one operation command carries address information of the at least one physical unit. The command queue is configured to cache the at least one operation command. The at least one physical unit may be included in at least one of the physical groups 41(1) to 41(n). According to the analysis result of the at least one operation command, the memory control circuit 23 may determine the at least one idle buffer from the buffers 42(1) to 42(n).

In an embodiment, the memory control circuit 23 may determine whether the physical groups 41(1) to 41(n) corresponding to each of the buffers 42(1) to 42(n) are full of data. If a physical group is full of data, the buffer corresponding to the corresponding physical group may be set to a higher priority of an idle buffer.

In an embodiment, according to the analysis result of the at least one operation command, the memory control circuit 23 may determine at least one physical unit (also referred to as a candidate physical unit) to be accessed by the at least one operation command. The memory control circuit 23 may determine at least one physical group (also referred to as a candidate physical group) to which the at least one candidate physical unit belongs from the physical groups 41(1) to 41(n). The memory control circuit 23 may determine at least one buffer (also referred to as a candidate buffer) from the buffers 42(1) to 42(n) according to the at least one candidate physical group. Each candidate buffer is connected to one candidate physical group. Then, the memory control circuit 23 may determine the at least one idle buffer from the buffers 42(1) to 42(n). In particular, the at least one idle buffer does not include the at least one candidate buffer. For example, the memory control circuit 23 may determine the at least one buffer in the buffers 42(1) to 42(n) that is not a candidate buffer as an idle buffer. Thereafter, the memory control circuit 23 may determine a second buffer from the at least one idle buffer. Therefore, it may be ensured that during the subsequent execution of the at least one operation command, the access behavior for the at least one operation command does not use (i.e., does not involve) the second buffer.

In an embodiment, the first physical unit and the second physical unit are located at the same word line (also referred to as a first word line) in the memory module 122. Taking the MLC mode as an example, a plurality of memory cells located in the first word line in the memory module 122 may form two physical units. The two physical units include a first type physical unit and a second type physical unit. The first type physical unit is configured to store the least significant bit (LSB). The second type physical unit is configured to store the most significant bit (MSB). In an embodiment, the first physical unit may be one of the first type physical unit and the second type physical unit located at the first word line, and the second physical unit may be the other of the first type physical unit and the second type physical unit located at the first word line.

Alternatively, taking the TLC mode as an example, a plurality of memory cells located in the first word line in the memory module 122 may form three physical units. The three physical units include a first type physical unit, a second type physical unit, and a third type physical unit. The first type physical unit is configured to store the least significant bit (LSB). The second type physical unit is configured to store the most significant bit (MSB). The third type of physical unit is configured to store a central significant bit (CSB). In an embodiment, the first physical unit may be one of the first type physical unit, the second type physical unit, and the third type physical unit located at the first word line, and the second physical unit may be another of the first type physical unit, the second type physical unit, and the third type physical unit located at the first word line. Alternatively, if the number of the second physical unit is a plurality, the second physical units may be the two of the first type physical unit, the second type physical unit, and the third type physical unit located at the first word line.

In an embodiment, when the first data is obtained but the second data is not completely obtained, the memory control circuit 23 caches the first data in the first buffer and temporarily does not execute the operation of writing the first data into the first physical unit. Taking the MLC mode as an example, after the first data and the second data are completely obtained, the first data and the second data are continuously stored in the first physical unit and the second physical unit located at the same word line (i.e., the first word line) to effectively improve the stability of the stored data. Similarly, in the MLC mode, the TLC mode, or other operation modes, continuously programming a plurality of physical units located at the same word line may effectively improve the stability of the stored data. That is, after the first data and the second data make up enough data for one word line, the first data and the second data are stored in the same word line in the memory module 122. In an embodiment, the first physical unit and the second physical unit may not be located at the same word line in the memory module 122, and the invention is not limited thereto.

In an embodiment, when the first data is obtained but the second data is not completely obtained, the memory control circuit 23 caches the first data in the first buffer and sets a time threshold. If the pause time of not executing the operation of writing the first data to the first physical unit exceeds the time threshold, invalid data may be filled as the second data, or the incomplete second data may be filled with invalid data.

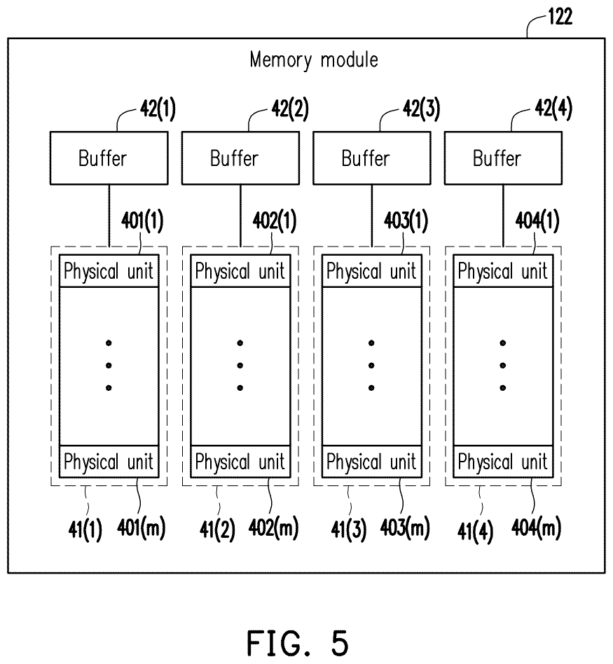

FIG. 5 is a schematic diagram of a memory module shown according to an embodiment of the invention. Referring to FIG. 5, it is assumed that the memory module 122 includes physical groups 41(1) to 41(4) and buffers 42(1) to 42(4). The physical group 41(1) includes physical units 401(1) to 401(m). The physical group 41(2) includes physical units 402(1) to 402(m). The physical group 41(3) includes physical units 403(1) to 403(m). The physical group 41(4) includes physical units 404(1) to 404(m). Moreover, the buffers 42(1) to 42(4) are connected to the physical groups 41(1) to 41(4) respectively.

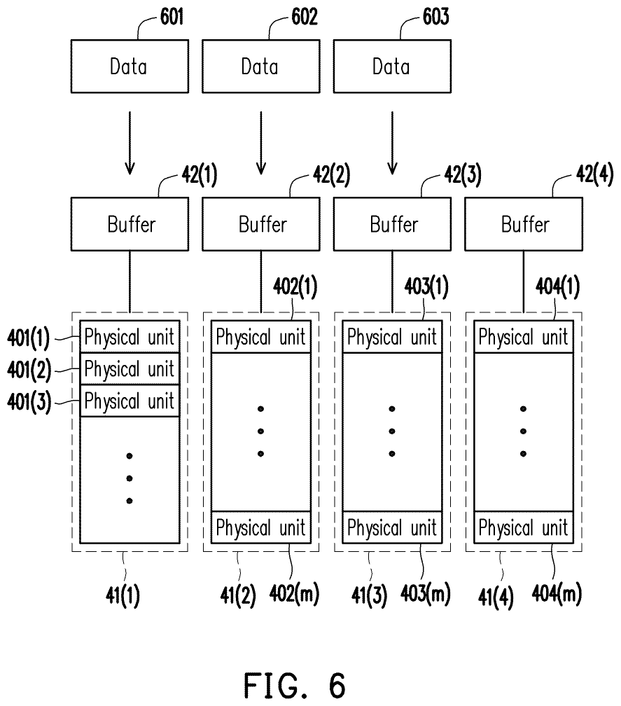

FIG. 6 to FIG. 9 are schematic diagrams of data storage operations shown according to an embodiment of the invention. Referring to FIG. 6, continuing from the embodiment of FIG. 5, it is assumed that data 601 to 603 are preset to be stored in the physical units 401(1) to 401(3) in the physical group 41(1) respectively. In an embodiment, the physical units 401(1) to 401(3) may be located at the same word line (i.e., the first word line). In an embodiment, the physical units 401(1) to 401(3) may not be located at the same word line, and the invention is not limited thereto.

In an embodiment, it is assumed that the capacity of the buffer 42(i) is insufficient to simultaneously buffer the data 601 to 603 (or at least two of the data 601 to 603). Therefore, the memory control circuit 23 may cache the data 601 (i.e., the first data) in the buffer 42(1). Moreover, the memory control circuit 23 may identify idle buffers from the remaining buffers 42(2) to 42(4). For example, assuming that the buffers 42(2) and 42(3) are idle buffers, the memory control circuit 23 may cache the data 602 and 603 (i.e., the second data) in the buffers 42(2) and 42(3) respectively.

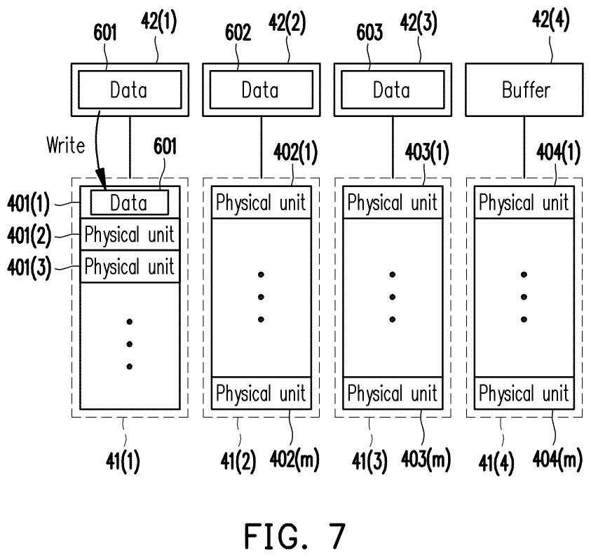

Referring to FIG. 7, after the data 601 to 603 are cached in the buffers 42(1) to 42(3) respectively, the memory control circuit 23 may instruct the memory module 122 to start storing (e.g., writing) the data 601 currently cached in the buffer 42(1) in the physical unit 401(1).

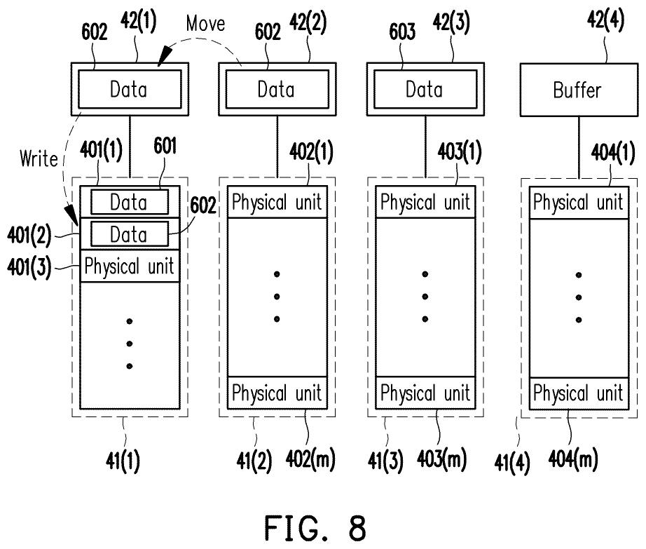

Referring to FIG. 8, after the data 601 is stored in the physical unit 401(1), the memory control circuit 23 may move (e.g., copy) the data 602 currently cached in the buffer 42(2) to the buffer 42(1). For example, after the data 602 is moved to the buffer 42(1), the data 601 originally cached in the buffer 42(1) may be replaced (e.g., overwritten). Then, the memory control circuit 23 may instruct the memory module 122 to store the data 602 currently cached in the buffer 42(1) in the physical unit 401(2).

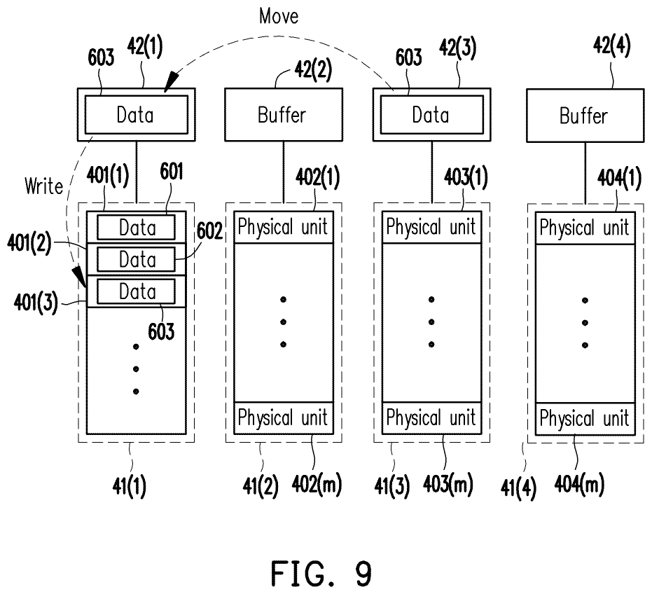

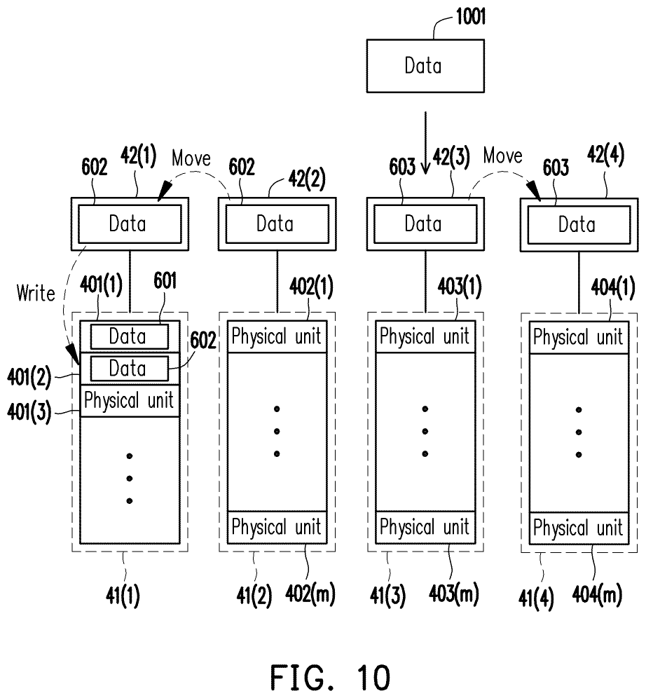

Referring to FIG. 9, after the data 602 is stored in the physical unit 401(2), the memory control circuit 23 may also move the data 603 currently cached in the buffer 42(3) to the buffer 42(1). For example, after the data 603 is moved to the buffer 42(1), the data 602 originally cached in the buffer 42(1) may be replaced. Then, the memory control circuit 23 may instruct the memory module 122 to store the data 603 currently cached in the buffer 42(1) in the physical unit 401(3).

It should be noted that in an embodiment, in the operation of moving data from a certain buffer (also called the original buffer) to another buffer (also called the new buffer), the memory control circuit 23 may first read the data from the original buffer to the outside of the memory module 122, and then store the data back to the new buffer in the memory module 122.

Alternatively, in an embodiment, in the operation of moving data from the original buffer to the new buffer, the moved data may also be transferred across buffers within the memory module 122 without being read outside the memory module 122, and the invention is not limited thereto.

Returning to FIG. 4, in an embodiment, the memory control circuit 23 may also obtain another data (also referred to as third data). For example, the third data may include data stored in accordance with at least one operation command (e.g., a write command) obtained from the host system 11 or data read from the memory module 122, and the invention is not limited thereto.

In an embodiment, it is assumed that the third data is expected to be stored in the second physical group, however, the first data and the second data are currently cached in the first buffer and the second buffer, respectively. In this case, since the second buffer is already occupied by the second data, the third data may not be stored in the second physical group via the second buffer.

In an embodiment, after the third data is obtained, the memory control circuit 23 may determine one buffer (also referred to as a third buffer) from at least one idle buffer in the buffers 42(1) to 42(n) not including the first buffer and the second buffer. The third buffer is connected to a certain physical group (also referred to as a third physical group) in the physical groups 41(1) to 41(n). Then, the memory control circuit 23 may move (i.e., cache) the second data currently cached in the second buffer to the third buffer.

After the second data cached in the second buffer is cached in the third buffer, the memory control circuit 23 may cache the third data in the second buffer to replace the second data originally cached in the second buffer. Therefore, the third data may wait in the second buffer to be subsequently stored in the second physical group. Later, the memory control circuit 23 may store the first data cached in the first buffer and the second data cached in the third buffer in the first physical group.

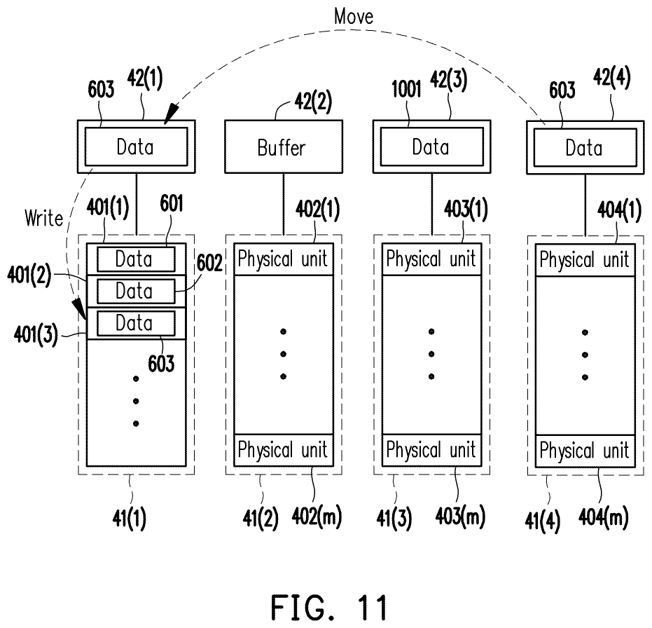

FIG. 10 and FIG. 11 are schematic diagrams of data storage operations shown according to an embodiment of the invention. Referring to FIG. 10, continuing from the embodiment of FIG. 8, it is assumed that while the data 603 is still cached in the buffer 42(3) waiting to be stored in the physical unit 401(3), data 1001 (i.e., the third data) is obtained. In particular, the data 1001 is expected to be stored in one of the physical units 403(1) to 403(m) belonging to the physical group 41(3).

In an embodiment, after the buffer 42(4) is determined as an idle buffer, the memory control circuit 23 may move the data 603 currently cached in the buffer 42(3) to the buffer 42(4). After the data 603 is moved to the buffer 42(4), the memory control circuit 23 may cache the data 1001 in the buffer 42(3) to replace the data 603 originally cached in the buffer 42(3). Therefore, the data 1001 may be stored from the buffer 42(3) to the physical group 41(3) at any time. Moreover, after the data 602 is moved to the buffer 42(1), the memory control circuit 23 may instruct the memory module 122 to store the data 602 currently cached in the buffer 42(1) in the physical unit 401(2).

Referring to FIG. 11, after the data 602 is stored in the physical unit 401(2), the memory control circuit 23 may move the data 603 currently cached in the buffer 42(4) to the buffer 42(1). Then, the memory control circuit 23 may instruct the memory module 122 to store the data 603 currently cached in the buffer 42(1) in the physical unit 401(3).

In an embodiment, the memory control circuit 23 may continuously track the cache location change status of data (e.g., the second data) in the plurality of buffers in the memory module 122. Then, the memory control circuit 23 may complete the storage of the data according to the tracked cache location change status. The relevant operation details are described above (for example, refer to the embodiments of FIG. 5 to FIG. 11, but the invention is not limited thereto), and are not repeated herein.

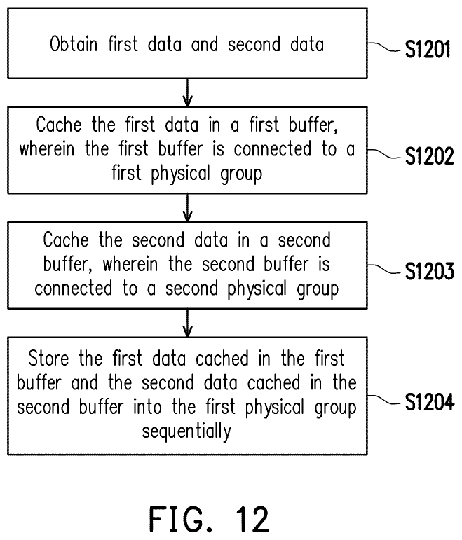

FIG. 12 is a flowchart of a data storage method shown according to an embodiment of the invention. Referring to FIG. 12, in step S1201, first data and second data are obtained. In step S1202, the first data is cached in a first buffer, wherein the first buffer is connected to a first physical group. In step S1203, the second data is cached in a second buffer, wherein the second buffer is connected to a second physical group. In step S1204, the first data cached in the first buffer and the second data cached in the second buffer are sequentially stored in the first physical group.

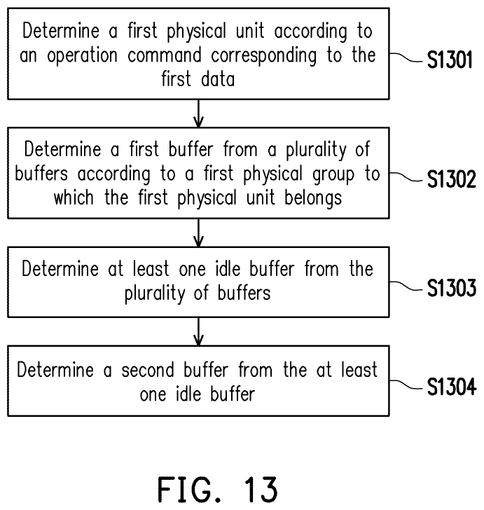

FIG. 13 is a flowchart of a data storage method shown according to an embodiment of the invention. Referring to FIG. 13, in step S1301, a first physical unit is determined according to an operation command corresponding to first data. In step S1302, a first buffer is determined from a plurality of buffers according to a first physical group to which the first physical unit belongs. In step S1303, at least one idle buffer is determined from the plurality of buffers. In step S1304, a second buffer is determined from the at least one idle buffer.

However, each step in FIG. 12 and FIG. 13 is described in detail above and is not repeated herein. It is worth noting that each step in FIG. 12 and FIG. 13 may be implemented as a plurality of program codes or circuits, and the invention is not limited thereto. In addition, the method of FIG. 12 and FIG. 13 may be used in conjunction with the above exemplary embodiments or may be used alone, and is not limited by the invention.

Based on the above, the data storage method and the storage device provided by the invention can, after the data expected to be stored in the first physical group is obtained, cache part of the data (i.e., the second data) in the data in the buffer (i.e., the second buffer) connected to another physical group (i.e., the second physical group) in a dispersed manner, so as to solve the issue of insufficient capacity of the buffer (i.e., the first buffer) connected to the first physical group. Therefore, it is possible to ensure that the data write operation on the memory module may still be smoothly executed without additionally increasing the capacity of the buffer and the write amplification. At the same time, balance may be achieved between reducing costs, maintaining basic data write operations, and reducing write amplification.

Lastly, it should be noted that the above embodiments are used to describe the technical solutions of the invention instead of limiting them. Although the invention has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the invention.

What is claimed is:

1. A data storage method, used in a storage device, wherein the storage device comprises a memory module, the memory module comprises a plurality of buffers and a plurality of physical groups, the plurality of buffers are respectively connected to the plurality of physical groups, and the data storage method comprises:
obtaining first data and second data;
caching the first data in a first buffer in the plurality of buffers, wherein the first buffer is connected to a first physical group in the plurality of physical groups;
caching the second data in a second buffer in the plurality of buffers, wherein the second buffer is connected to a second physical group in the plurality of physical groups; and
storing the first data cached in the first buffer and the second data cached in the second buffer sequentially in the first physical group.

2. The data storage method of claim 1, wherein the first physical group comprises a first physical unit and a second physical unit, and the step of storing the first data cached in the first buffer and the second data cached in the second buffer sequentially in the first physical group comprises:
storing the first data cached in the first buffer in the first physical unit; and
storing the second data cached in the second buffer in the second physical unit via the first buffer after the first data is stored in the first physical unit.

3. The data storage method of claim 2, wherein the step of storing the second data cached in the second buffer in the second physical unit via the first buffer after the first data is stored in the first physical unit comprises:
moving the second data cached in the second buffer to the first buffer to replace the first data originally stored in the first buffer after the first data is stored in the first physical unit; and
storing the second data cached in the first buffer in the second physical unit.

4. The data storage method of claim 2, further comprising:
determining the first physical unit according to an operation command corresponding to the first data;
determining the first buffer from the plurality of buffers according to the first physical group to which the first physical unit belongs;
determining at least one idle buffer from the plurality of buffers; and
determining the second buffer from the at least one idle buffer.

5. The data storage method of claim 4, wherein the step of determining the second buffer from the at least one idle buffer comprises:
analyzing at least one operation command in a command queue; and
determining the at least one idle buffer from the plurality of buffers according to an analysis result of the at least one operation command.

6. The data storage method of claim 5, wherein the step of determining the at least one idle buffer from the plurality of buffers according to the analysis result of the at least one operation command comprises:
determining at least one candidate physical unit to be accessed as instructed by the at least one operation command according to the analysis result;
determining at least one candidate physical group to which the at least one candidate physical unit belongs from the plurality of physical groups;
determining at least one candidate buffer from the plurality of buffers according to the at least one candidate physical group, wherein the at least one candidate buffer is connected to the at least one candidate physical group; and
determining the at least one idle buffer from the plurality of buffers, wherein the at least one idle buffer does not comprise the at least one candidate buffer.

7. The data storage method of claim 2, wherein the first physical unit and the second physical unit are located at a same word line in the memory module.

8. The data storage method of claim 7, further comprising:
pausing an operation of writing the first data into the first physical unit temporarily after the first data is cached in the first buffer in a case that the first data is obtained but the second data is not completely obtained.

9. The data storage method of claim 1, wherein the step of storing the first data cached in the first buffer and the second data cached in the second buffer to the first physical group comprises:
obtaining third data;
determining a third buffer from at least one idle buffer in the plurality of buffers not comprising the first buffer and the second buffer in a case that an operation command corresponding to the third data points to the second physical group, wherein the third buffer is connected to a third physical group in the plurality of physical groups;
caching the second data cached in the second buffer in the third buffer;
caching the third data in the second cache to replace the second data originally cached in the second buffer after the second data cached in the second buffer is cached in the third buffer; and
storing the first data cached in the first buffer and the second data cached in the third buffer in the first physical group.

10. The data storage method of claim 1, wherein each of the physical groups in the plurality of physical groups corresponds to one plane in the memory module.

11. A storage device, comprising:
a connection interface configured to be connected to a host system;
a memory module; and
a memory controller connected to the connection interface and the memory module,
wherein the memory module comprises a plurality of buffers and a plurality of physical groups, the plurality of buffers are respectively connected to the plurality of physical groups, and the memory controller is configured to:
obtain first data and second data;
cache the first data in a first buffer in the plurality of buffers, wherein the first buffer is connected to a first physical group in the plurality of physical groups;
cache the second data in a second buffer in the plurality of buffers, wherein the second buffer is connected to a second physical group in the plurality of physical groups; and
store the first data cached in the first buffer and the second data cached in the second buffer sequentially in the first physical group.

12. The storage device of claim 11, wherein the first physical group comprises a first physical unit and a second physical unit, and the operation of the memory controller storing the first data cached in the first buffer and the second data cached in the second buffer sequentially in the first physical group comprises:
storing the first data cached in the first buffer in the first physical unit; and
storing the second data cached in the second buffer in the second physical unit via the first buffer after the first data is stored in the first physical unit.

13. The storage device of claim 12, wherein the operation of storing the second data cached in the second buffer in the second physical unit via the first buffer after the first data is stored in the first physical unit comprises:
moving the second data cached in the second buffer to the first buffer to replace the first data originally stored in the first buffer after the first data is stored in the first physical unit; and
storing the second data cached in the first buffer in the second physical unit.

14. The storage device of claim 12, wherein the memory controller is further configured to:
determine the first physical unit according to an operation command corresponding to the first data;
determine the first buffer from the plurality of buffers according to the first physical group to which the first physical unit belongs;
determine at least one idle buffer from the plurality of buffers; and
determine the second buffer from the at least one idle buffer.

15. The storage device of claim 14, wherein the operation of the memory controller determining the second buffer from the at least one idle buffer comprises:
analyzing at least one operation command in a command queue; and
determining the at least one idle buffer from the plurality of buffers according to an analysis result of the at least one operation command.

16. The storage device of claim 15, wherein the operation of determining the at least one idle buffer from the plurality of buffers according to the analysis result of the at least one operation command comprises:
determining at least one candidate physical unit to be accessed as instructed by the at least one operation command according to the analysis result;
determining at least one candidate physical group to which the at least one candidate physical unit belongs from the plurality of physical groups;
determining at least one candidate buffer from the plurality of buffers according to the at least one candidate physical group, wherein the at least one candidate buffer is connected to the at least one candidate physical group; and
determining the at least one idle buffer from the plurality of buffers, wherein the at least one idle buffer does not comprise the at least one candidate buffer.

17. The storage device of claim 12, wherein the first physical unit and the second physical unit are located at a same word line in the memory module.

18. The storage device of claim 17, wherein the memory controller is further configured to:
pause an operation of writing the first data into the first physical unit temporarily after the first data is cached in the first buffer in a case that the first data is obtained but the second data is not completely obtained.

19. The storage device of claim 11, wherein the operation of the memory controller storing the first data cached in the first buffer and the second data cached in the second buffer in the first physical group comprises:
obtaining third data;
determining a third buffer from at least one idle buffer in the plurality of buffers not comprising the first buffer and the second buffer in a case that the operation command corresponding to the third data points to the second physical group, wherein the third buffer is connected to a third physical group in the plurality of physical groups;
caching the second data cached in the second buffer in the third buffer;
caching the third data in the second cache to replace the second data originally cached in the second buffer after the second data cached in the second buffer is cached in the third buffer; and
storing the first data cached in the first buffer and the second data cached in the third buffer in the first physical group.

20. The storage device of claim 11, wherein each of the physical groups in the plurality of physical groups corresponds to one plane in the memory module.
